(19) United States
(12) Patent Application Publication
(10) Pub. No.: US 2011/0223564 A1
(43) Pub. Date: Sep. 15, 2011

(54) Magnetic connector

(76) Inventors: Donald Lee West, Winchester, KY (US); Arthur Dean Sperow, Nicholasville, KY (US)

(21) Appl. No.: 12/932,516

(22) Filed: Feb. 28, 2011

Related U.S. Application Data
(60) Provisional application No. 61/339,894, filed on Mar. 11, 2010.

(51) Int. Cl. A61C 13/235

(52) U.S. Cl. 433/189

(57) ABSTRACT

This invention claims a magnetic denture or prostheses connection device. Dental implants are an improved method for tooth replacement in that their performance is more similar to natural teeth than are common plate dentures. Unfortunately the implant method is more complex and difficult to build and install. This translates to higher cost to the patient. In the industry there is a variety of mechanisms for connecting a denture to a variety of implant coupling systems. There are both removable and non-removable types. Non-removable dentures are rigidly screwed to the implants or abutments, whereas removable types use snap-together plastic clips. Removable is better from a hygienic perspective.

Current coupling and connector devices are seldom a perfect fit even after much care and effort by the installer. This puts high forces on some implants and couplers, and imperfect mating of others. Resulting wear eventually requires repair and/or replacement of connector parts. Also it is important to have forces of chewing distributed as uniformly as possible to the jaw-bone. Concentrated forces can cause stresses at the high force areas and bone degradation of areas where no, or low, force occurs.

The high magnetic force of rare earth magnets provide adequate force to retain dentures. While there are many advocates who claim that magnets attached to various body parts do wonderful things, there is no conclusive scientific evidence that verifies these claims. Likewise there is the possibility that high magnetic fields may have harmful effects. For this reason it is desirable that the magnetic fields be contained within any device that will be attached to a place in the body for a long period of time. This invention accomplishes its primary function in a superior fashion while at the same time conserving safety and general health for the applicant. Little, or no, external magnetic fields exist and are totally removed when the denture is removed. These advantages also apply to other applicable prostheses.

This application claims priority to and benefit of U.S. Provisional Patent Application Ser. No. 61/339,894 filed Mar. 11, 2010, entitled “Magnetic Connector.”

### FIELD OF THE INVENTION

The field of dentistry applies to a range of involvement with oral health from care and maintenance to repair and tooth replacement. This invention relates, primarily, to tooth replacement. Two most used replacement methods of present time are dentures that are retained by suction and bone implant devices to which denture are attached. From earliest history of tooth replacement, implantation was considered and attempted. Available materials and limited medical knowledge did not allow the implant concept to flourish until more recent times. Even so, certain limitations have kept implantation from being the most used method. Cost and complexity of implant hardware, along with preparation and installation time, are major impediments. It remains more an art than a science.

Various suppliers of somewhat differing hardware designs offer precision parts machined mostly from titanium metal and molded Nylon plastics. Most offer fixed angle adapters with complicated means to get “close enough” to the desired angle and elevation. Some vendors offer self-aligning denture fastening clips that are limited to two axes of movement. This leaves the height parameter, which is seldom a perfect fit of all the connection points. Imperfect fit of connectors causes wear and loss of connection strength over passage of time.

### SUMMARY OF INVENTION

This invention utilizes the high force of rare-earth magnets to retain dentures. Along with a unique denture structure and installation procedure, precise alignment and fit are easily attained.

Easy removal and replacement by the wearer allows better hygiene. Because the magnets are retained in the denture they can be easily removed for certain medical procedures such as MRI (Magnetic Resonance Imaging.) Also unique to this invention, when installed, insignificant external magnetic fields occur. All these benefits also apply when used for certain external body prostheses.

### BRIEF DESCRIPTION OF DRAWINGS

FIG. 1 is an assembly drawing depicting the magnetic connector assembly portion 2, contained by the denture base 1, shown separated from connector platform assembly consisting of shunt 3 and platform 4, in a typical application of connecting a denture to a typical implant assembly, consisting of threaded post 5 and bone implant 6. A nominal gum margin is represented by line 7. A nominal bone margin is represented by line 8.

FIG. 2 depicts a normal magnetic field 2A-2 of a cylindrical magnet 2A-1. 2B illustrates the field confinement method for this proposed invention. Magnets 1a and 1b with opposed poles are positioned between low reluctance field shunts 2a and 2b. Oblique views 2C and 2D provide further clarification of the assembly.

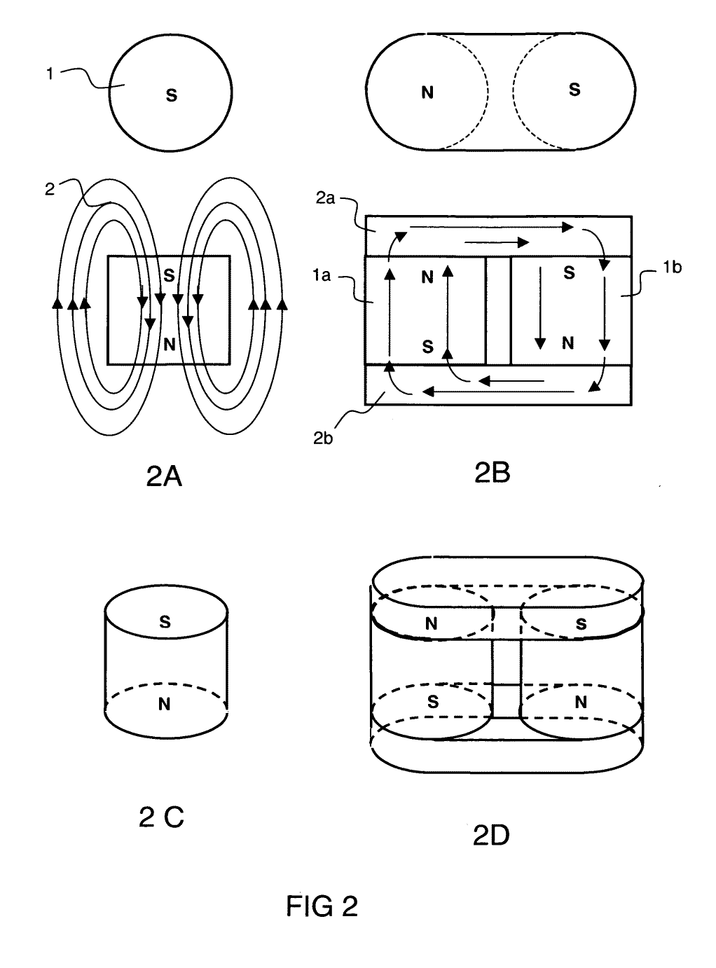

FIG. 3 presents various combinations of magnet and shunt components to accommodate different strengths and heights of the magnetic connector assembly. 3A and 3D show external magnetic field patterns of free magnets. 3B, 3C and 3E demonstrate the field confinement effects of various shunting configurations. 3B depicts opposed cylinder magnets with metallic shunts. 3C depicts opposed cylinder magnets with magnet shunts. 3E depicts a metallic shunt and plate magnet.

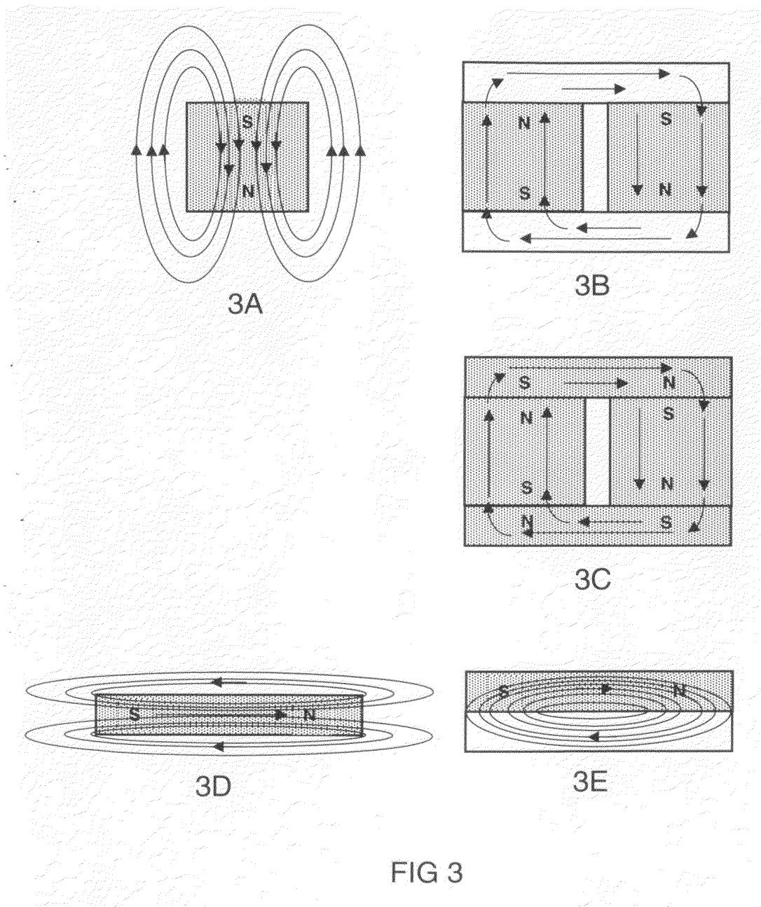

FIG. 4 depicts the attachment platform assembly that connects the magnetic assembly, described by FIG. 2 and FIG. 3, to a mechanism that is attached to a body part such as a jaw bone. The platform assembly is comprised of a low reluctance shunt 1 secured to tray part 2. The magnetic shunt is bound to the tray part 2 by mechanical compression or adhesive means. Aspects 3 and 4 are appropriate for dental applications as depicted in FIG. 1, but may be altered for other applications.

### DESCRIPTION OF PREFERRED EMBODIMENTS

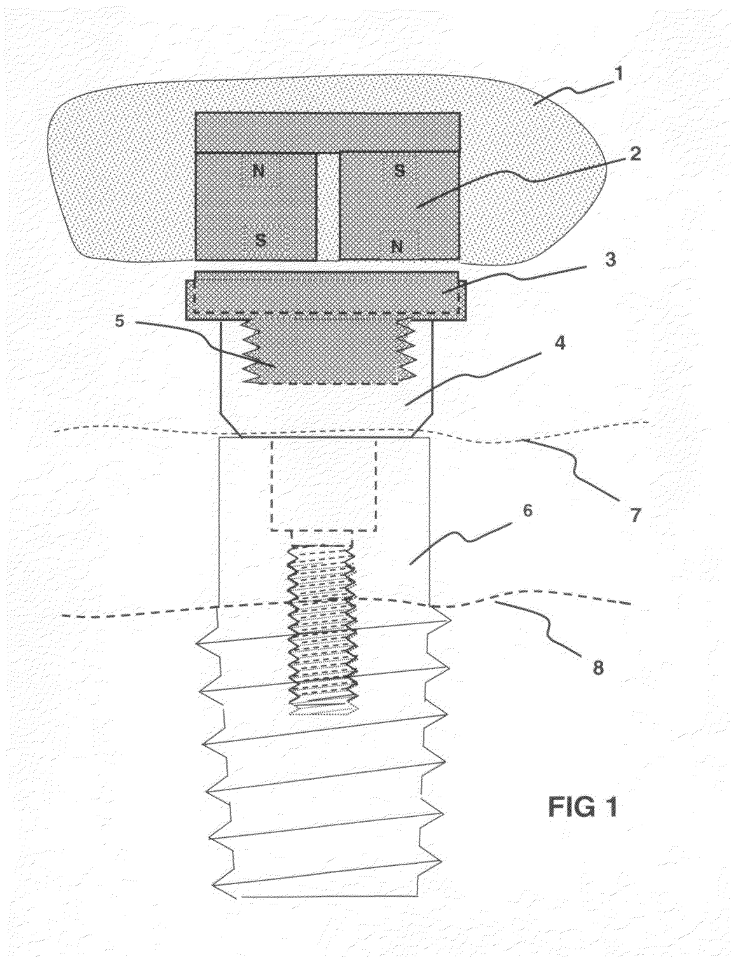

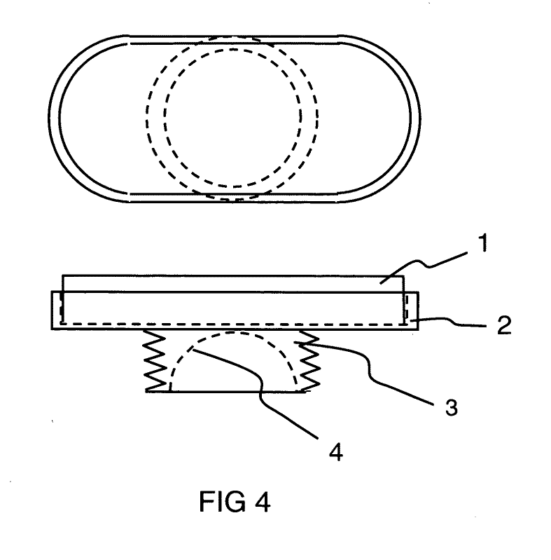

As indicated by FIG. 1, the primary application of the magnetic coupler is for connecting dentures to dental implant abutments. Implants are screwed into holes that are drilled into jawbone. Irregularity of jawbone structure after removal of the teeth prevents any regular positioning of the implants. Various methods and attachment devices are available to provide uniformity at the connector base such that the connector platform of FIG. 4 will be in a level plane with the other abutment platforms.

In dental applications, the position and orientation of the platforms will be established and a denture frame will be made for an exact fit. In prostheses applications, meshes and plates of appropriate materials, sizes and shapes can be attached to the magnet assemblies. A prosthesis is cast or formed to retain the magnetic coupler assembly.

What is claimed:

1. In combination, an attachment part with magnets and magnetic field shunts that are uniquely configured to produce a high force coupling mechanism with minimal external magnetic fields.

2. The invention of claim 1 is specifically arranged to attach artificial body parts to surgically implanted parts whereas:
a) said artificial parts can be easily attached and removed.
b) said artificial parts may be dentures.
c) said artificial parts may be facial or other body part prostheses.

3. The invention of claim 1 whereby essentially all magnetic fields are contained within the coupling mechanism whereas:
a) magnets and shunts are arranged and sized such that the chosen shunt material will accommodate and contain all or most of the magnet field.

4. The invention of claim 2 whereby a shunt is fixed to an attachment part such that:
a) artificial parts can be attached to bone.
b) artificial parts can be attached to soft tissue.

5. The method of claim 2 whereby the magnet, or magnets, is or are retained in the removable parts.
